(19) United States
(12) Patent Application Publication
(10) Pub. No.: US 2008/0242317 A1
(43) Pub. Date: Oct. 2, 2008

(54) Mobile content creation, sharing, and commerce in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/728,848

(22) Filed: Mar. 26, 2007

(51) Int. Cl. H04Q 7/20

(52) U.S. Cl. 455/456.3

(57) ABSTRACT

A method, apparatus, and system of a mobile content creation, sharing, and commerce in a geo-spatial environment are disclosed. In one embodiment, a method includes communicating a positioning data of the mobile device to a server at a periodic interval, automatically generating in the mobile device, in response to the server, a present location profile associated with a present geographic location of the mobile device, simultaneously generating, in the mobile device, a set of adjacent profiles provided by the server as being a direction away from the present geographic location of the mobile device and refreshing, in the mobile device, the present location profile and the set of adjacent profiles at the periodic interval. The method may include automatically attaching a present sense data in the present location profile when a user selects a capture function in the present location profile.

This patent application is being filed simultaneously with a PCT patent application, titled “MOBILE CONTENT CREATION, SHARING, AND COMMERCE IN A GEO-SPATIAL ENVIRONMENT”.

### FIELD OF TECHNOLOGY

This disclosure relates generally to the technical fields of communications and, in one example embodiment, to a method, an apparatus, and a system of a mobile content creation, sharing, and commerce in a geo-spatial environment.

### BACKGROUND

A search engine (e.g., Google®, Yahoo®, etc.) may have a mobile version optimized for a browser (e.g., Microsoft® Windows CE, PalmOS®, etc.) of a mobile device (e.g., a cellular phone). A user of the mobile device may enter information to be searched using the search engine in the browser of the mobile device. However, sometimes, the user may not know exactly what he/she is looking for, and as such may choose to walk and/or drive around a street/neighborhood instead of using the search engine. The user may have to spend hours and/or days in a particular neighborhood before becoming familiar with it by walking and/or driving around.

For example, John may travel to Paris, France for the first time and may wish to find interesting things to do while in Paris. Since John has never been to Paris, he may not know what exactly he is looking for. As a result, John may prefer to walk around streets of Paris rather than using Google® or Yahoo® on his mobile phone (e.g., the search engine) because John may not know what exactly to specifically search for. John may need to spend hours in Paris (or even weeks in Paris) before becoming familiar with the neighborhood.

Similarly, the user may not know exactly where he/she currently is (e.g., an address of present location) when using the mobile device in relation to nearby residences and/or businesses. As a result, the user may not be able to understand how far away he/she is from local listings in the search engine. For example, John may not know how far he is from the Eiffel Tower when wandering around Paris streets. A mapping section (e.g., Google® Maps, Yahoo® Maps) of the search engine may not work because John may need to enter a starting address that he does not possess.

Also, while browsing the neighborhood, the user may have a present-sense impression (e.g., comments and/or observations) about a place being visited (e.g., a business, a home, a landmark, an event, etc.). For example, the present sense impression may be a statement made by the user that conveys his or her sense of a state of an event or a condition of something. The statement may be spontaneously made while the user is perceiving (e.g., contemporaneous with) the event or condition, or “immediately thereafter.” The permissible time lapse between the event and the statement may range from seconds to minutes (e.g., but probably not hours). The present sense impression may include opinions, inferences, recommendations, feelings, and/or conclusions about a location presently being perceived. For example, the present sense impression may be the user saying, “it's cold in this store” or an expressing opinion on a restaurant's food when dining at the restaurant and/or taking a video/photograph. The user may not know exactly what address he/she is at when making the present sense impressions. As such, the present sense impressions of the user may not be shared with other parties.

For example, while exploring, John may make an interesting observation (e.g., the present sense impression) about businesses and/or people he visits in Paris. However, John may not know exactly what address corresponds to the place where he made the interesting observation. As such, John may need to take detailed notes to capture and share the interesting observation with others. John may not have the time to do this, may only have a short time to spend in Paris, and may not speak French well enough to always ask people where he is. As such, John may not be able to fully discover Paris, and may not be able to share the interesting observations with others.

### SUMMARY

A method, apparatus and system of mobile content creation, sharing, and commerce in a geo-spatial environment are disclosed. In one aspect, a method includes communicating a positioning data of a mobile device to a server at a periodic interval, automatically generating in the mobile device, in response to the server, a present location profile associated with a present geographic location of the mobile device, simultaneously generating, in the mobile device, a set of adjacent profiles provided by the server as being a direction away from the present geographic location of the mobile device, and refreshing in the mobile device, the present location profile and the set of adjacent profiles at the periodic interval.

In addition, the method may include automatically attaching a present sense data (e.g., the present sense data may be a textual data, a visual data, an auditory data, a video data and/or an audio-visual data surrounding a place presently being perceived by user the of the mobile device) in the present location profile when the user selects a capture function in the present location profile. The method may further include providing a wiki interface that may enable the user of the mobile device to add profiles and/or to modify any information associated with the present sense profile and/or the set of adjacent profiles when the present sense profile and the set of adjacent profiles (e.g., the present location profile and the set of adjacent profiles may include both residential and business listings) may not be claimed by another user.

The method may also include locking certain profiles when they have been claimed by a claiming user at the discretion of the claiming user. The method may further include applying a triangulation algorithm (e.g., the triangulation algorithm may be a global positioning algorithm and/or a radio algorithm) to generate a compass view in the mobile device that may represent each adjacent profile as being in front of, behind, to the left of, and/or to the right of the mobile device. The method may also include generating, in the mobile device, a coupon provided by a business in a vicinity of the present geographic location of the mobile device. In addition, the method may include redeeming in the mobile device the coupon through a mobile payment algorithm when the user may purchase an item associated with the coupon and/or reserving the item at the business in the vicinity of the present geographic location of the mobile device.

Furthermore, the method may include generating a classified view of purchasable items at homes near the present geographic location of the mobile device when residents of the homes market goods they no longer want (e.g., by marking them as a free status, a for loan status, a for rent status, and a for sale status) in a geo-spatial social network associated with the server and/or publishing an announcement of the residents to be shared with mobile devices around homes of the residents who publish the announcement.

The method may further include generating directions between the mobile device and an adjacent location without requiring the user of the mobile device to enter a starting address by applying a directions algorithm based on the positioning data of the mobile device as the starting address and a destination address identified in a particular adjacent profile associated with the adjacent location. Moreover, the method may include viewing the present location profile and the set of adjacent location profiles of the mobile device in a satellite mode, a three-dimensional mode, and a flat-text mode.

The method may further include forming groups between the user of the mobile device and/or other mobile and non-mobile users of the geo-spatial social network based on shared interests and placing a marker based on the positioning data of the mobile device in the geo-spatial social network to display a present location of the user to other non-mobile and mobile users of the geo-spatial social network.

The method may also include creating a temporary message through the mobile device that may be coordinated based on the positioning information of the mobile device to a geo-spatial social network location and/or which resides in the geo-spatial social network only for a threshold amount of time prior to being purged from the geo-spatial social network, and generating a marker visible around profiles of adjacent businesses and residences in the geo-spatial social network that represents the temporary message.

In another aspect, a system includes a server to simplify a geo-spatial social network to operate through a mobile communications infrastructure, in which profiles of the geo-spatial social network may be editable by any user of the geo-spatial social network until they are claimed by a user of the geo-spatial social network, and a mobile device to generate a view of profiles of the geo-spatial social network that may be a threshold radius away from the mobile device and to automatically capture content to be appended to wiki profiles of the geo-spatial social network by attaching a location data of the mobile device acquired through a positioning module of the mobile device with a particular wiki profile of the geo-spatial social network.

Furthermore, the system may include an advertising module to capture classified advertisements, messages, and/or coupons from businesses and residents surrounding the mobile device and to share them with a user of the mobile device.

In yet another aspect, a method includes sharing a present location of mobile users of a geo-spatial social network with other users through markers corresponding to a latitude and longitude position of mobile devices associated with the mobile users in a three-dimensional neighborhood view, appending content to profiles of the geo-spatial social network based on a written, an audio, and a video content provided through the mobile devices associated with the mobile users, and/or automatically providing editable business and/or residential profiles that have not been claimed surrounding the mobile devices to the mobile devices so that the mobile users of the mobile devices have an ability to modify the editable business and/or residential profiles. In addition, the method may include associating a three-dimensional neighborhood data with each profile using an interpolation algorithm to match each profile to a specific neighborhood in the three-dimensional neighborhood data.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a server communicating with a geo-spatial environment and a mobile device through a network, according to one embodiment.

FIG. 2 is an exploded view of the profile module of FIG. 1, according to one embodiment.

FIG. 3 is an exploded view of the marker module of FIG. 1, according to one embodiment.

FIG. 4 is a user interface view of the mobile device of FIG. 1 illustrating a temporary message, according to one embodiment.

FIG. 5 is a user interface view of the mobile device of FIG. 1 illustrating driving directions and the businesses in the geo-spatial network, according to one embodiment.

FIG. 6 is a user interface view of the mobile device of FIG. 1 illustrating classified advertisements, coupons, messages surrounding the mobile device in the geo-spatial environment, according to one embodiment.

FIG. 7 is a user interface view of the mobile device of FIG. 1 illustrating visual data, auditory data and video data surrounding the mobile device of the user, according to one embodiment.

FIG. 8 is a diagrammatic system view of a data processing system in which any of the embodiments disclosed herein may be performed, according to one embodiment.

FIG. 9 is a table view showing details of a physical location surrounding the mobile device, according to one embodiment.

FIG. 10 is a table view showing navigation details to the user of the mobile device, according to one embodiment.

FIG. 11A is a process flow of generating a present location profile and a set of adjacent profiles in the mobile device, according to one embodiment.

FIG. 11B is a continuation of process flow of FIG. 11A illustrating additional processes, according to one embodiment.

FIG. 11C is a continuation of process flow of FIG. 11B illustrating additional processes, according to one embodiment.

FIG. 12 is a process flow of sharing a present location of the mobile user with the other users through markers, according to one embodiment.

Other features of the present embodiments will be apparent from the accompanying drawings and from the detailed description that follows:

### DETAILED DESCRIPTION

A method, apparatus and system of mobile content creation, sharing, and commerce in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

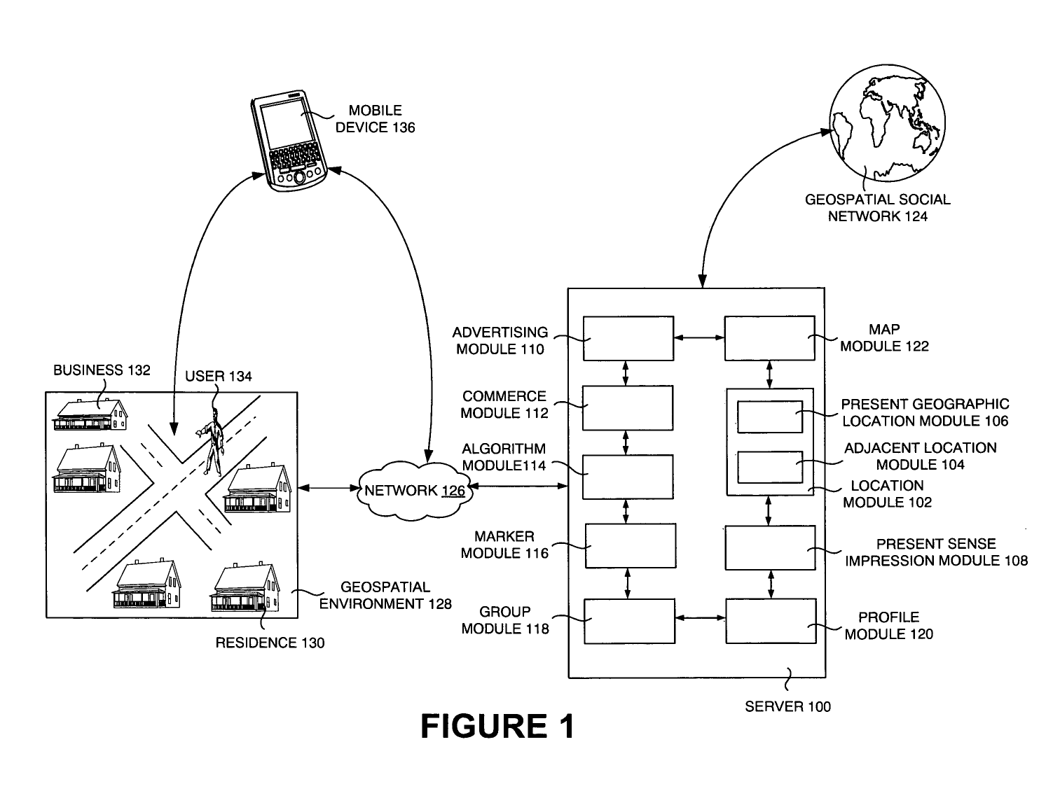

In one embodiment, a method includes communicating a positioning data of a mobile device (e.g., the mobile device 136 of FIG. 1) to a server (e.g., the server 100 of FIG. 1) at a periodic interval, automatically generating in the mobile device 136, in response to the server, a present location profile associated with a present geographic location of the mobile device 136, simultaneously generating, in the mobile device 136, a set of adjacent profiles provided by the server as being a direction away from the present geographic location of the mobile device 136, and refreshing in the mobile device 136, the present location profile and/or the set of adjacent profiles at the periodic interval.

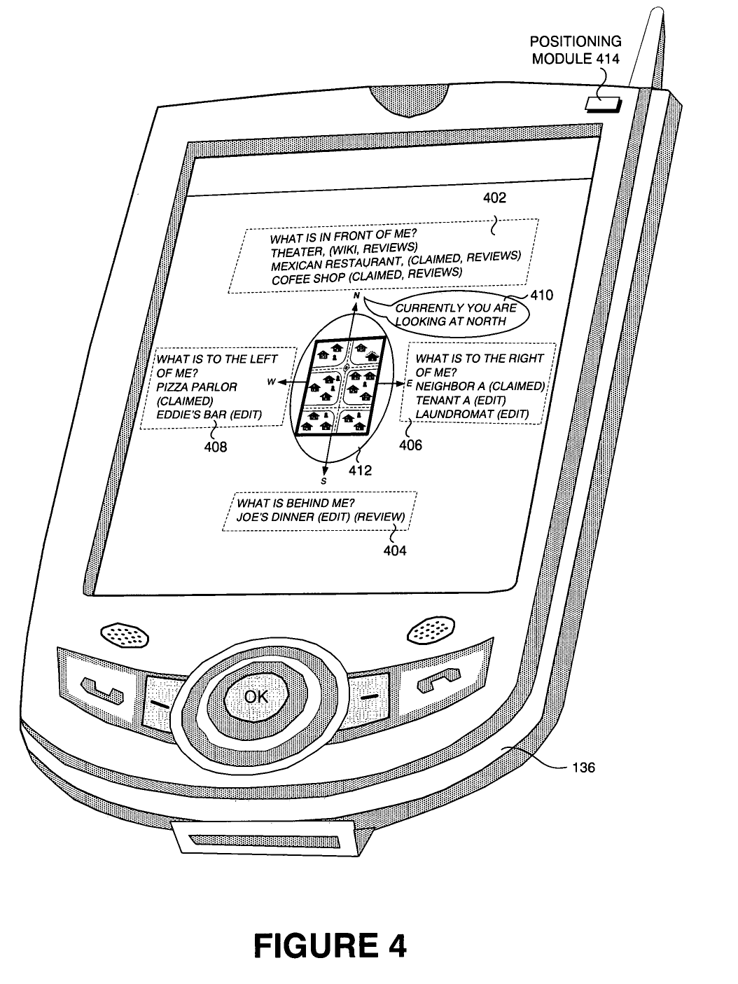

In another embodiment, a system includes a server to simplify a geo-spatial social network (e.g., the geo-spatial social network 124 of FIG. 1) to operate through a mobile communications infrastructure, in which profiles of the geo-spatial social network 124 are editable by any user of the geo-spatial social network 124 until they are claimed by a user of the geo-spatial social network 124, and a mobile device 136 to generate a view of profiles of the geo-spatial social network 124 that are a threshold radius away from the mobile device 136 and to automatically capture content to be appended to wiki profiles of the geo-spatial social network 124 by attaching a location data of the mobile device 136 acquired through a positioning module (e.g., the positioning module 414 of FIG. 4) of the mobile device 136 with a particular wiki profile of the geo-spatial social network 124.

In yet another embodiment, a method includes sharing a present location of mobile users of a geo-spatial social network 124 with other users through markers corresponding to a latitude and longitude position of mobile devices 136 associated with the mobile users in a three-dimensional neighborhood view, appending content to profiles of the geo-spatial social network 124 based on written, audio, and/or video content provided through the mobile devices 136 associated with the mobile users, and automatically providing editable business and/or residential profiles that have not been claimed surrounding the mobile devices 136 to the mobile devices 136 so that the mobile users of the mobile devices 136 have an ability to modify the editable business and/or residential profiles.

FIG. 1 is a system view of a server 100 communicating with a geo-spatial environment 128 and a mobile device 136 through a network 126, according to one embodiment. Particularly, FIG. 1 illustrates the server 100, a location module 102, an adjacent location module 104, a present geographic location module 106, a present sense impression module 108, an advertising module 110, a commerce module 112, an algorithm module 114, a marker module 116, a group module 118, a profile module 120, a map module 122, a geo-spatial social network 124, the network 126, the geo-spatial environment 128, a residence 130, a business 132, a user 134 and a mobile device 136, according to one embodiment.

The server 100 may enable a simplified communication in the geo-spatial network through a mobile communication infrastructure. The location module 102 may position the user 134 of the mobile device 136 in the geo-spatial environment 128. The adjacent location module 104 may provide details of an adjacent location of the user 134 of the mobile device 136. The present geographic location module 106 may display the current geographic location of the user 134 of the mobile device 136 in the geo-spatial environment 128.

The present sense impression module 108 may capture the present sense data (e.g., a textual data, a visual data, an auditory data, a video data, etc.) surrounding the location presently being perceived by the user 134 of the mobile device 136. The advertising module 110 may capture classified advertisements, messages, and/or coupons from businesses and/or residences surrounding the mobile device 136 and/or may enable sharing them with other users of the geo-spatial environment 128. The commerce module 112 may allow transactions and/or businesses among the users (e.g., residents, businesses, etc.) in the geo-spatial environment 128.

The algorithm module 114 may apply various algorithms (e.g., a triangulation algorithm, a directions algorithm, and/or an interpolation algorithm) to help the user 134 of the mobile device 136 to position the various location profiles in the geo-spatial environment 128. The marker module 116 may generate a marker which corresponds to a latitude and longitude position of mobile devices associated with the mobile user in a three-dimensional neighborhood view and/or may enable sharing of the present location of user 134 and/or business 132 in the geo-spatial network 124. The group module 118 may enable creation of groups between the user 134 of the mobile device 136 and other mobile and/or non-mobile users of the geo-spatial network 124 based on shared interest. The profile module 120 may generate the present location profile and/or the adjacent location profile of the user 134 of the mobile device 136 through communicating the position data of the mobile device 136 to the server 100 at periodic intervals.

The map module 122 may generate a map view of the geo-spatial social network 124 to locate the presently perceived physical location of the user 134 of the mobile device 136. The geo-spatial social network 124 may be a communication network for interaction between the users in the geo-spatial environment 128 and/or may be simplified by the server 100 to operate through a mobile communication infrastructure. The network 126 may allow communication between the server 100 and the geo-spatial environment 128 to generate location data of the user 134 of the mobile device 136. The geo-spatial environment 128 may be the three dimensional neighborhood view of the geo-spatial network 124.

The residence 130 may represent the physical location occupied by occupant(s) of the geo-spatial environment 128. The business 132 may represent the businesses available in the geo-spatial environment 128. The user 134 may be an entity in the geo-spatial network 124 accessing the mobile device 136 to communicate with the entities (e.g., businesses, persons, etc.) in the geo-spatial network 124. The mobile device 136 may be a personal communication device (e.g., a mobile phone, a PDA, etc.) which is used to generate a view of the profiles of the geo-spatial network 124, located threshold radius away from the mobile device 136.

In the example embodiment illustrated in FIG. 1, the server 100 communicates with the geo-spatial environment 128 and the mobile device 136 through the network 126. The server 100 communicates with the geo-spatial network 124. In addition, the server 100 consists of the location module 102, the present sense impression module 108, the advertising module 110, the commerce module 112, the algorithm module 114, the marker module 116, the group module 118, and the profile module 120 communicating with each other, according to the example embodiment illustrated in FIG. 1.

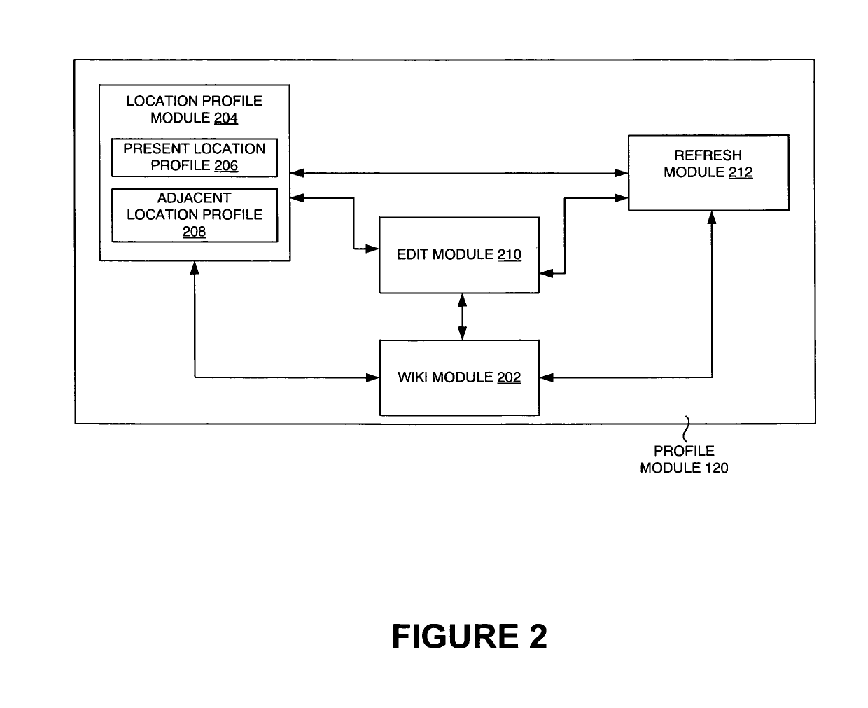

The positioning data (e.g., of the mobile device 136) may be communicated to the server 100 at periodic intervals. In addition, a present location profile (e.g., the present location profile 206 of FIG. 2) associated with a present geographic location of the mobile device 136 may be automatically generated in the mobile device 136 in response to the server. The set of the adjacent profiles (e.g., the adjacent location profile 208 of FIG. 2) provided by the server 100 may be simultaneously generated in the mobile device 136 as being a direction away from the present geographic location of the mobile device 136. In addition, the present sense data (e.g., the textual data, the visual data, the auditory data, the video data, and/or the audio-visual data) in the present location profile as perceived by the user 134 of the mobile device 136 may be automatically attached when the user 134 selects a capture function in the present location profile.

A triangulation algorithm (e.g., a global positioning algorithm and/or a radio algorithm) may be applied to generate a compass view in the mobile device 136 that represents each adjacent profile as being in front of, behind, to the left of, and to the right of the mobile device 136. Moreover, a classified view of purchasable items at homes near the present geographic location of the mobile device 136 may be generated when residents of the homes market goods they no longer want (e.g., by marking the goods as having a free status, a for loan status, a for rent status, and/or a for sale status) in the geo-spatial social network associated with the server (e.g., the server 100 of FIG. 1). Also, an announcement of the residents may be published to be shared with mobile devices around homes of the residents who publish the announcement.

In addition, groups may be formed between the users of the mobile device 136 and other mobile and/or non-mobile users of the geo-spatial social network 124 based on shared interests. Markers may be placed based on the positioning data of the mobile device 136 in the geo-spatial social network 124 to display the present location of the user 134 to the other non-mobile and mobile users of the geo-spatial social network 124. The server 100 may simplify the geo-spatial social network 124 to operate through the mobile communications infrastructure, in which profiles of the geo-spatial social network 124 are editable by any user of the geo-spatial social network 124 until they are claimed by the user of the geo-spatial social network 124.

The mobile device 136 may generate views of profiles of the geo-spatial social network 124 that are a threshold radius away from the mobile device 136, and/or may automatically capture content to be appended to wiki profiles of the geo-spatial social network by attaching the location data of the mobile device 136 acquired through the positioning module (e.g., the positioning module 414 of FIG. 4) of the mobile device 136 with the particular wiki profile of the geo-spatial social network 124.

The advertising module 110 may capture the classified advertisements, the messages, and/or the coupons from the businesses and/or residents surrounding the mobile device 136 and/or to share them with the user 134 of the mobile device 136. In addition, the present location of mobile users of the geo-spatial social network 124 may be shared with other users through markers corresponding to the latitude and longitude position of mobile devices associated with the mobile users in the three-dimensional neighborhood view. Three-dimensional neighborhood data may be associated with each profile using an interpolation algorithm to match each profile to a specific neighborhood in the three-dimensional neighborhood data.

FIG. 2 is an exploded view of the profile module 120 of FIG. 1, according to one embodiment. Particularly, FIG. 2 illustrates a wiki module 202, a location profile module 204, a present location profile 206, an adjacent location profile 208, an edit module 210 and a refresh module 212, according to one embodiment.

The wiki module 202 may provide a wiki interface where the user of the mobile device 136 may add and/or modify profiles of the other users who have not claimed their profiles in the geo-spatial network. The location profile module 204 may provide details of a location associated with the user 134 of the mobile device 136. The present location profile 206 may provide information of the current location of the user 134 in the geo-spatial network. The adjacent location profile 208 may generate profiles adjacent to the physical location perceived by the user of the mobile device 136 in the geo-spatial network.

The edit module 210 may update the profile details associated with the location of the user 134 of the mobile device 136 at periodic intervals when the user 134 moves from one location to another in the geo-spatial network. The refresh module 212 may automatically refresh the location profiles (e.g., the present location profile 206 and/or the adjacent location profile 208) in the mobile device(s) of the user in the geo-spatial social network.

In the example embodiment illustrated in FIG. 2, the location profile module 204 having present location profile 206 and adjacent location profile 208 communicates with the wiki module 202, the edit module 210 and the refresh module 212. The wiki module 202 communicates with the edit module 210 and the refresh module 212, according to the example embodiment of FIG. 2.

The present location profile and/or the set of adjacent profiles may be refreshed in the mobile device at the periodic interval. The wiki interface that enables the user of the mobile device 136 (e.g., the mobile device 136 of FIG. 1) to add profiles and/or to modify any information associated with the present sense profile and/or the set of adjacent profiles may be provided when the present sense profile and/or the set of adjacent profiles are not claimed by another user. Also, certain profiles may be locked (e.g., when they have been claimed by a claiming user at the discretion of the claiming user).

Content may be appended to the profiles of the geo-spatial social network (e.g., based on a written, an audio, and/or a video content provided through the mobile devices associated with the mobile users). Editable business and/or residential profiles that have not been claimed (e.g., surrounding the mobile devices) may be provided to the mobile devices so that the mobile users of the mobile devices have an ability to modify the editable business and/or residential profiles.

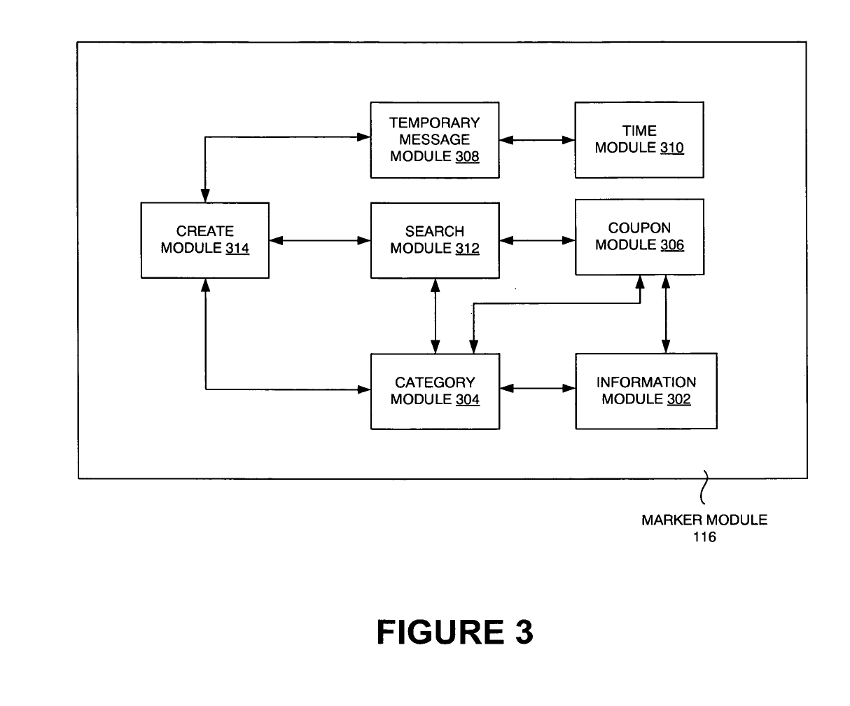

FIG. 3 is an exploded view of the marker module 116 of FIG. 1, according to one embodiment. Particularly, FIG. 3 illustrates an information module 302, a category module 304, a coupon module 306, a temporary message module 308, a time module 310, a search module 312 and a create module 314, according to one embodiment. The information module 302 may provide positioning information associated with the user of the mobile device(s) of the geo-spatial social network so that the users of the mobile device can locate their neighborhood using various markers in the geo-spatial environment. The category module 304 may categorize the markers based on various businesses and/or residential listings in the geo-spatial social network. The coupon module 306 may generate different coupons (e.g., based on category) that are visualized by means of markers.

The temporary message module 308 may create temporary messages of the businesses and/or residences so that the user of the mobile device is updated on events happening in the neighborhood of the geo-spatial environment. The time module 310 may decide the threshold amount of the time for the temporary message to exist in the mobile device of the geo-spatial social network prior to being purged from the geo-spatial network. The search module 312 may enable a preference search by the user of the mobile devices based on the different listing (e.g., residence and/or business listing) available in the geo-spatial environment. The create module 314 may create the temporary message through the mobile device that is coordinated based on the positioning information of the mobile device.

In example embodiment illustrated in FIG. 3, the information module 302 communicates with the category module 304 and the coupon module 306. The category module 304 communicates with the search module 312 and the create module 314. Also, the create module 314 communicates with the temporary message module 308, the time module 310 and the search module 312, according to the example embodiment illustrated in FIG. 3.

Coupons provided by the businesses in the vicinity of the present geographic location of the mobile device 136 may be generated in the mobile device 136. Temporary messages may be created through the mobile device 136 that may be coordinated based on the positioning information of the mobile device 136 to the geo-spatial social network 124 location and which resides in the geo-spatial social network 124 only for the threshold amount of time prior to being purged from the geo-spatial social network 124. The markers (e.g., visible around profiles of adjacent businesses and/or residences) may be generated in the geo-spatial social network to represent the temporary messages.

FIG. 4 is a user interface view of the mobile device 136 of FIG. 1 illustrating the temporary message, according to one embodiment. Particularly, FIG. 4 illustrates a what is in front of me? option 402, a what is behind me? option 404, a what is to the right of me? option 406, a what is to the left of me? option 408, a currently you are looking at label 410, an option 412 and a positioning module 414, according to one embodiment.

The what is in front of me? option 402, the what is behind me? option 404, the what is to the right of me? option 406 and the what is to the left of me? option 408 may enable a user to generate the compass views that represent the profiles (e.g., the profiles may be the locations in front of, behind, to the right and/or left of the mobile device 136 in the geo-spatial network) in the vicinity of the present location perceived by the mobile device 136 in the geo-spatial network. The currently you are looking at label 410 may indicate the compass direction the user of the mobile device 136 is looking towards (e.g., North). The option 412 may facilitate navigation in the different directions and/or may generate a view desired by the user of the mobile device 136. The positioning module 414 may position exact present location and/or the set of adjacent locations as perceived by the user of the mobile device 136 in the geo-spatial network.

In the example embodiment illustrated in FIG. 4, the user interface view may enable the user to navigate in the different directions and to position the present location and/or the set of adjacent locations surrounding the mobile device 136 of the user. Furthermore, the triangulation algorithm (e.g., the global positioning algorithm and/or the radio algorithm) may be applied to generate the compass view in the mobile device 136 that represents adjacent profile as being in front of, behind, to the left of, and to the right of the mobile device.

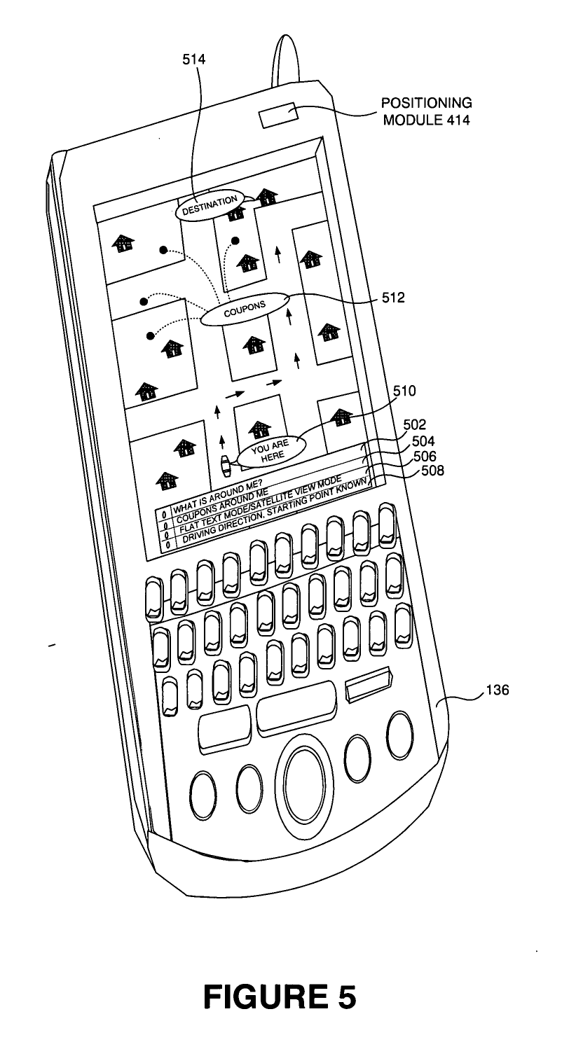

FIG. 5 is a user interface view of the mobile device 136 of FIG. 1 illustrating driving directions and the businesses in the geo-spatial network, according to one embodiment. Particularly, FIG. 5 illustrates a what is around me? option 502, a coupons around me option 504, a flat text mode/satellite view mode option 506, a driving direction, a starting point known option 508, a you are here option 510, a coupons option 512, a destination option 514 and the positioning module 414, according to one embodiment.

The what is around me? option 502 may enable the user to view adjacent profiles in the immediate neighborhood of the mobile device 136 in the geo-spatial environment. The coupons around me option 504 may facilitate user to choose different coupons provided by businesses in a vicinity of the present geographical location of the mobile device 136. The flat text mode/satellite view mode option 506 may facilitate the user of the mobile device 136 to view the present location profile and/or the adjacent location profiles in either flat text mode or satellite view mode.

The driving direction, starting point known option 508 may provide driving directions to the user of the mobile device 136 so that the user can navigate in the desired directions. The you are here option 510 may facilitate the user to visualize the present location as perceived by the user of the mobile device 136 in flat text mode or satellite view mode. The coupons option 512 may display the various coupons provided by the businesses and/or residences in the geo-spatial environment. The destination option 514 may indicate the driving directions and desired destination point of the user of the mobile device.

In the example embodiment illustrated in FIG. 5, the user interface view may enable the user of the mobile device 136 to locate themselves in the geo-spatial network and/or may provide the user with proper driving directions while navigating to desired destination points. The user interface view may also enable the user of the mobile device 136 to browse the coupons provided by the businesses and/or residents in the geo-spatial network through the mobile device 136.

Furthermore, the coupon provided by the business in the vicinity of the present geographic location of the mobile device 136 may be generated in the mobile device 136. The directions between the mobile device 136 and adjacent locations may be generated without requiring the user of the mobile device 136 to enter a starting address (e.g., by applying the directions algorithm based on the positioning data of the mobile device 136 as the starting address and/or a destination address identified in the particular adjacent profile associated with the adjacent location). Also, the present location profile and/or the set of adjacent location profiles of the mobile device 136 may be viewed in a satellite mode, a three-dimensional mode, and/or a flat-text mode.

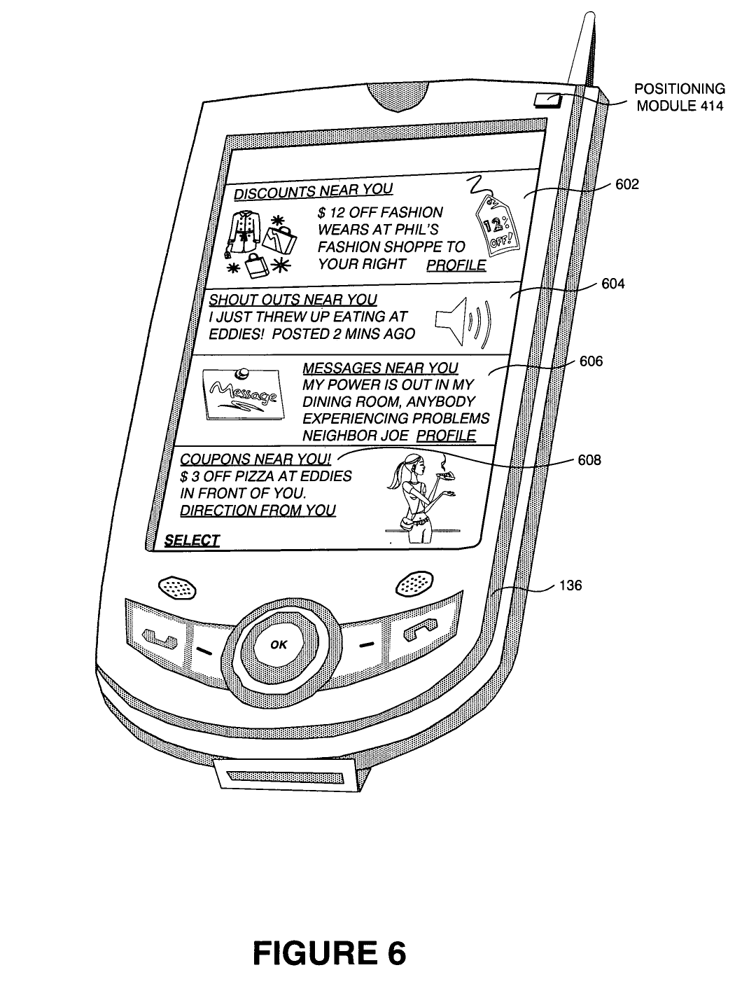

FIG. 6 is a user interface view of the mobile device 136 of FIG. 1 illustrating classified advertisements, coupons, and messages surrounding the mobile device 136 of the geo-spatial social network 124, according to one embodiment. Particularly, FIG. 6 illustrates the positioning module 414, a discounts near you option 602, a shout outs near you option 604, a messages near you option 606 and coupons near you option 608, according to one embodiment.

The discounts near you option 602 may enable the user of the mobile device to see goods and/or services in the geo-spatial environment that are available at a discounted rate. The shout outs near you option 604 may enable the user to share thoughts and/or comments among the users of the mobile device 136 in the geo-spatial network. The messages near you option 606 may enable the user of the mobile device 136 to socially interact with other users in the geo-spatial network through posting and/or viewing messages and/or comments. The coupons near you option 608 may facilitate the user of the mobile device 136 to purchase of items in exchange of coupons provided by the business in the vicinity of the present geographic location of the mobile device 136 in the geo-spatial network.

In the example embodiment illustrated in FIG. 6, the user interface view may enable the user of the mobile device 136 to perform business using the mobile device 136. The users may also be enabled to share thoughts and/or interests and interact with each other in the geo-spatial environment through the shouts outs near you option 604 and the messages near you option 606 respectively. Furthermore, the coupon may be redeemed in the mobile device 136 through a mobile payment algorithm when the user purchases an item associated with the coupon (e.g., the item at the business in the vicinity of the present geographic location of the mobile device may be reserved).

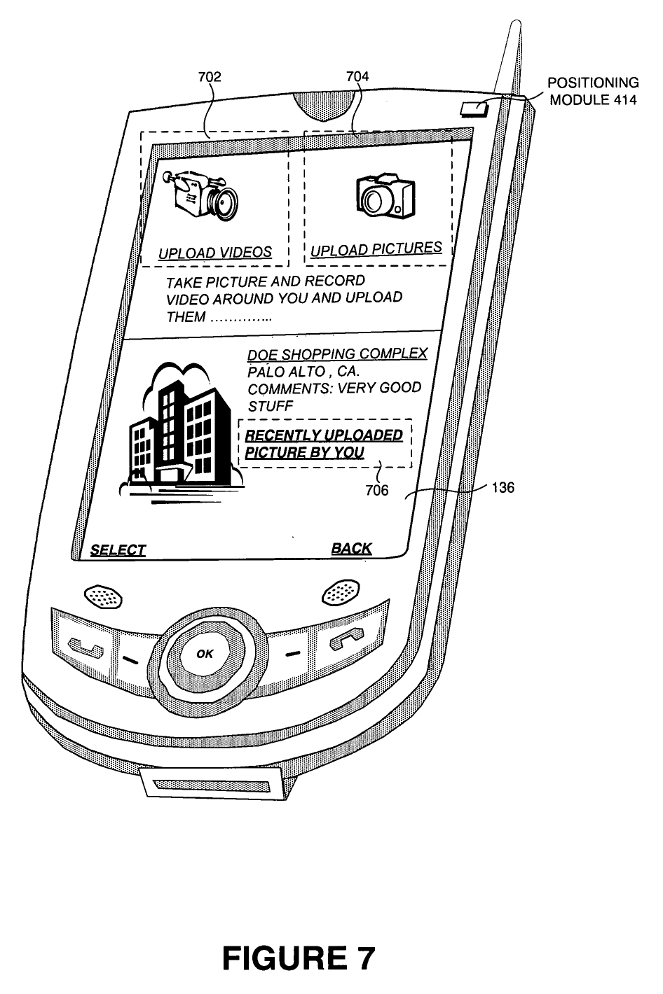

FIG. 7 is a user interface view of the mobile device 136 of FIG. 1 illustrating the visual data, auditory data and/or video data surrounding the mobile device of the user, according to one embodiment. Particularly, FIG. 7 illustrates an upload videos option 702, an upload pictures option 704, and an option 706, according to one embodiment.

The upload videos option 702 may enable the user to upload the video data and/or audio-visual data associated with the present location and the adjacent locations as perceived by the user of the mobile device. The upload pictures option 704 may enable the user to upload the captured visual data surrounding the present location perceived by the user of the mobile device 136 in the geo-spatial environment. The option 706 may enable the user of the mobile device 136 to visualize recently uploaded pictures and/or videos of the present location as perceived in the mobile device 136.

In the example embodiment illustrated in FIG. 7, the user interface view may enable the users to upload and/or view the recently uploaded videos and/or pictures as perceived by the user of the mobile device 136 in the geo-spatial environment.

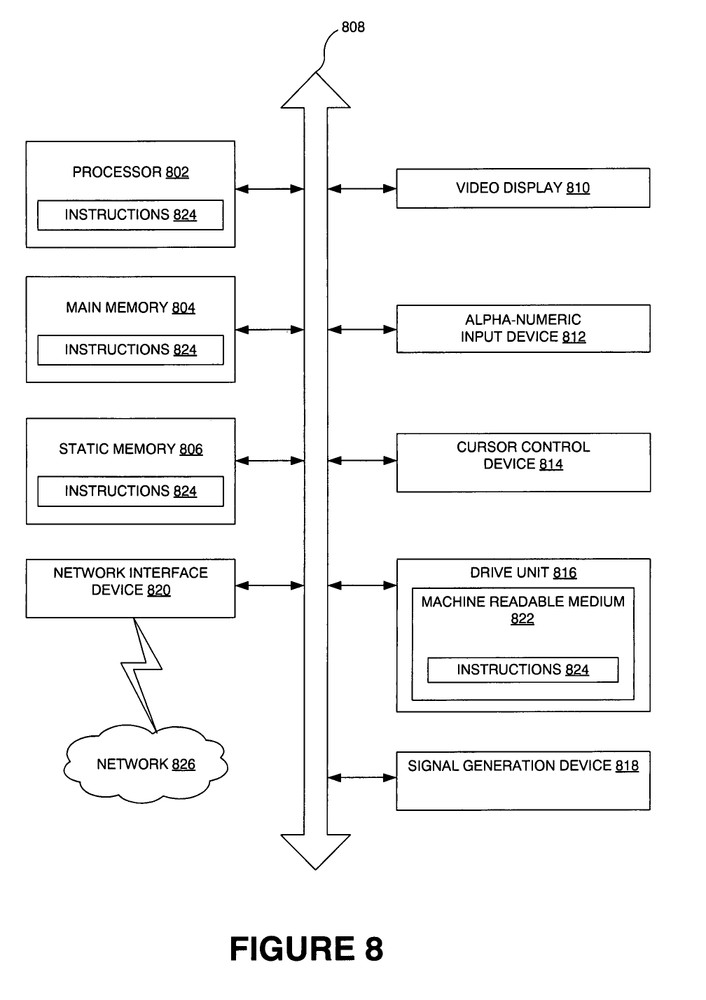

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or the data processing system in which one or more operations disclosed herein may be performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system. The static memory 806 may be a hard drive, a flash drive, and/or other memory information associated with the data processing system.

The bus 808 may be an inter-connection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one/or more operations disclosed herein.

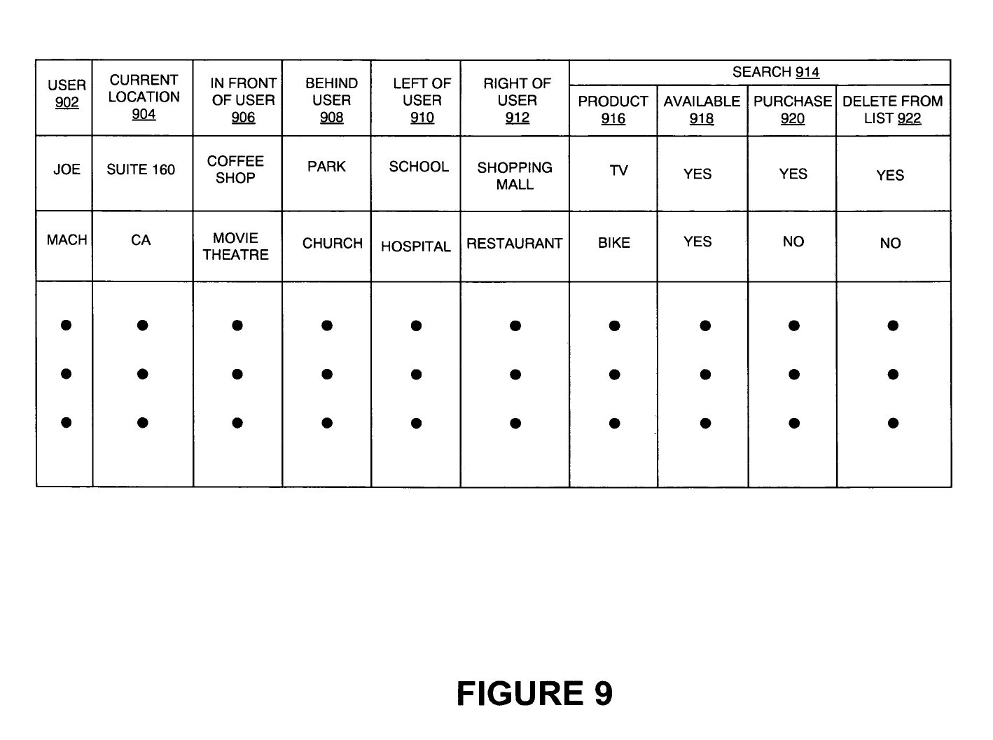

FIG. 9 is a table view showing details of the physical location surrounding the mobile device, according to one embodiment. Particularly, FIG. 9 illustrates a user field 902, a current location field 904, a in front of user field 906, a behind user field 908, a left of user field 910, a right of user field 912, and a search field 914, according to one embodiment. The search field 914 includes a product field 916, an available field 918, a purchase field 920, a delete from list field 922, according to one embodiment.

The user field 902 may display the name of person accessing the mobile device in the geo-spatial environment (e.g., the geo-spatial environment 128 of FIG. 1). The current location field 904 may display the present location of the mobile users of the geo-spatial social environment 128 through the markers which correspond to the latitude and longitude position of the mobile devices associated with the mobile users. The in front of user field 906, the behind user field 908, the left of user field 910, the right of user field 912 may display the adjacent location profiles surrounding the mobile device 136 as perceived by the user in the geo-spatial environment 128.

The search field 914 may display detailed information associated with the products and/or services requested by the user of the mobile device 136. The product field 916 may display the products available for sale (e.g., TV, Bike, etc) in the vicinity of the mobile device of the user. The available field 918 may display the status of the products available in the geo-spatial environment. The purchase field 920 may display the status (e.g., reserved, purchased, etc.) of the product provided by the business in the geo-spatial environment. The delete from list field 922 may show items deleted from the user list that are reserved and/or by another user of the mobile device 136.

In the example embodiment illustrated in FIG. 9, the user field 902 displays “Joe” in the first row and “Mach” in the second row of the user field column 902. The current location field 904 displays “Suite 160” in the first row and “CA” in the second row of the current location field column 904. The in front of user field 906 displays “coffee shop” in the first row and “movie theater” in the second row of the in front of user field column 906. The behind user field 908 displays “park” in the first row and “church” in the second row of the behind user field column 908. The left of user field 910 field displays “school” in the first row and “hospital” in the second row of the left of user field column 910. The right of user field 912 displays “shopping mall” in the first row and “restaurant” in the second row of the right of user field column 912. The product field 916 displays “TV” in the first row and “bike” in the second row of the product field column 916. The available field 918 displays “yes” in the first row and “yes” in the second row of the available field column 918. The purchase field 920 displays “yes” in the first row and “no” in the second row of the purchase field column 920. The delete from list field 922 displays “yes” in the first row and “no” in the second row of the delete from list field column 922.

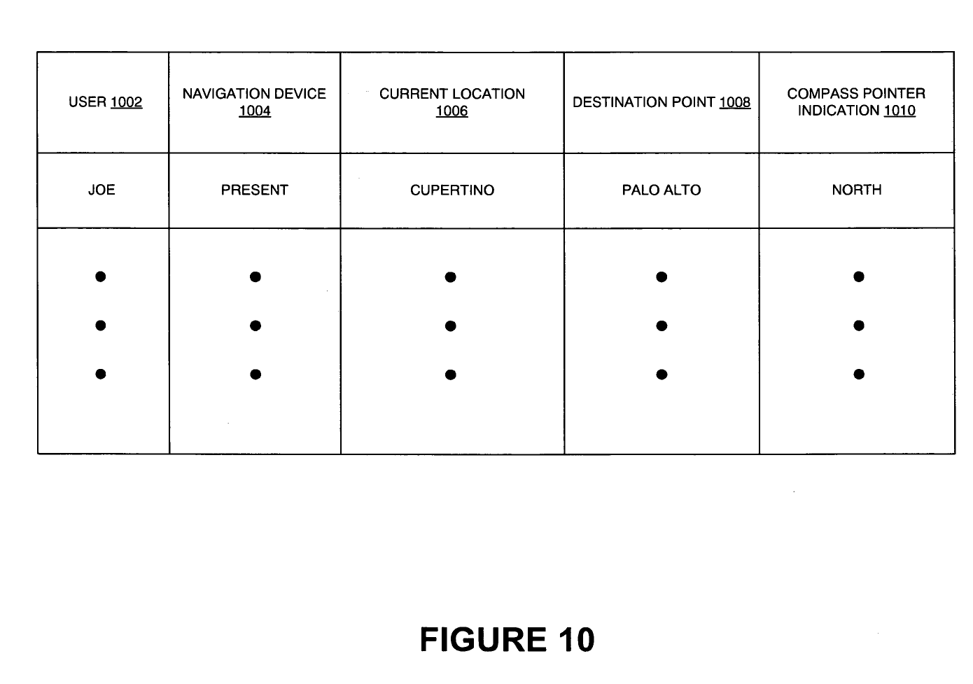

FIG. 10 is a table view showing navigation details of the user of the mobile device, according to one embodiment. Particularly, FIG. 10 illustrates a user field 1002, a navigation device field 1004, a current location field 1006, a destination point field 1008 and a compass pointer indication field 1010, according to one embodiment.

The user field 1002 may display the name of the user of the mobile device 136 in the geo-spatial social environment 128. The navigation device field 1004 may indicate the presence and/or absence of a navigation system in the mobile device 136. The current location field 1006 may display the current location associated with the user of the mobile device (e.g., the mobile device 136 of FIG. 1). The destination point field 1008 may display the destination point identified using particular profile associated with the adjacent location of the user of the mobile device 136. The compass pointer indication field 1010 may display the driving directions (e.g., north, east, west, south, etc.) between the current location of the user of the mobile device 136 and the destination point associated with the adjacent location.

In the example embodiment illustrated in FIG. 10, the user field 1002 displays “Joe” in the first row of the user field column 1002. The navigation device field 1004 displays “present” in the first row of the navigation device field column 1004. The current location field 1006 displays “Cupertino” in the first row of the current location field column 1006. The destination point field 1008 displays “Palo Alto” in the first row of the enter destination point field column 1008. The compass pointer indication field 1010 displays “north” in the first row of the compass pointer indication field column 1010.

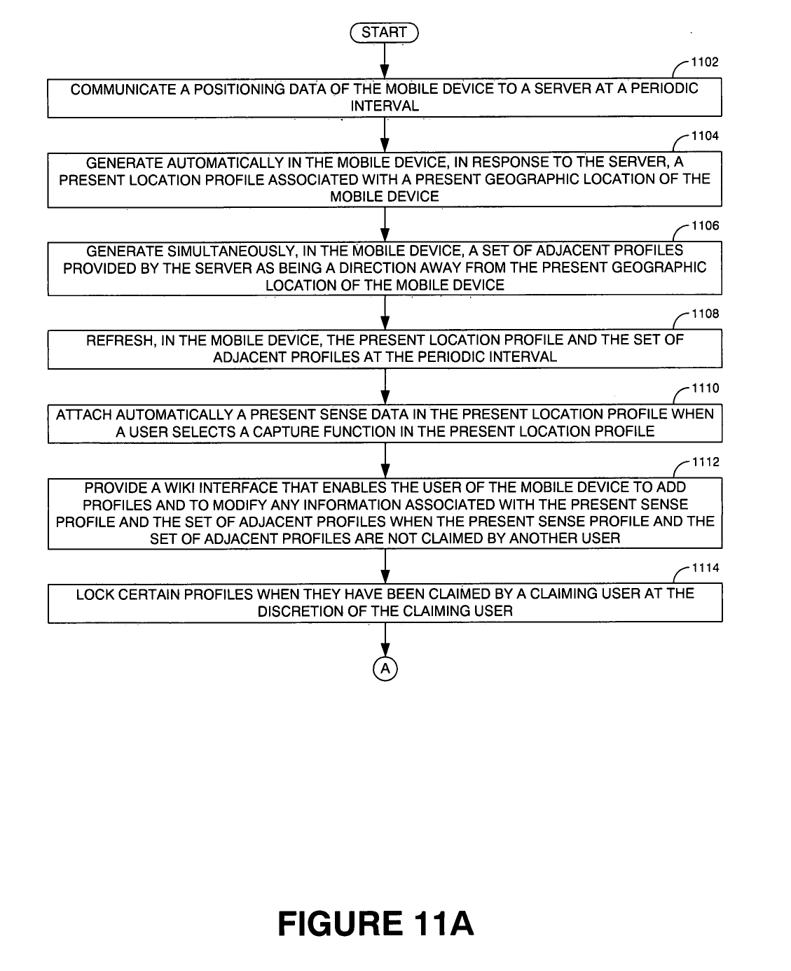

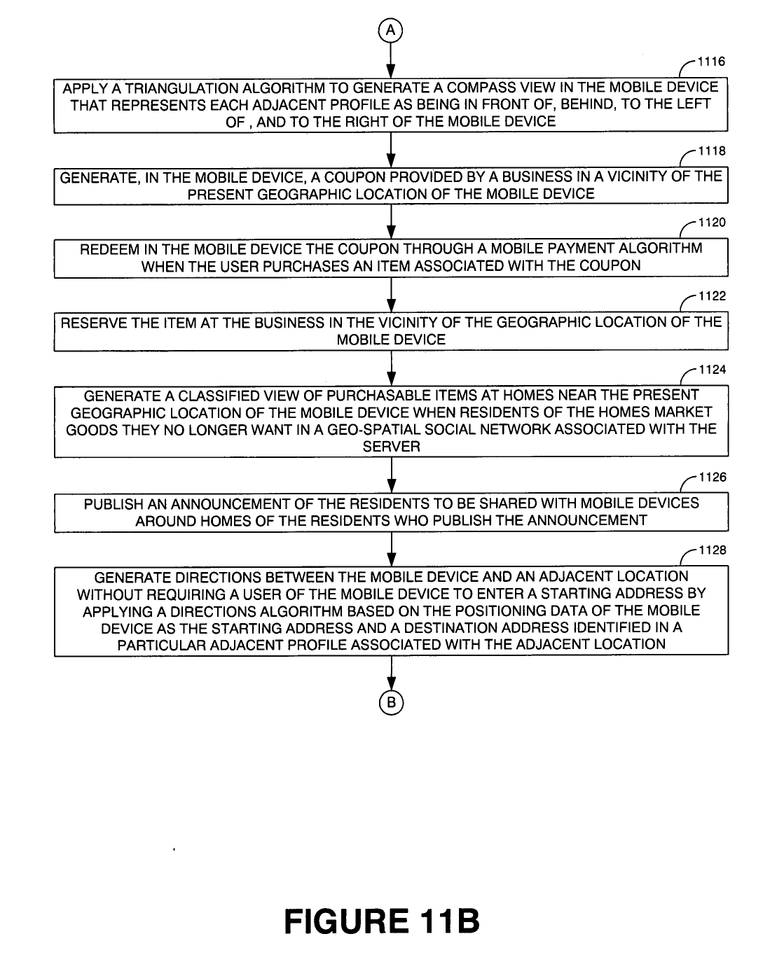

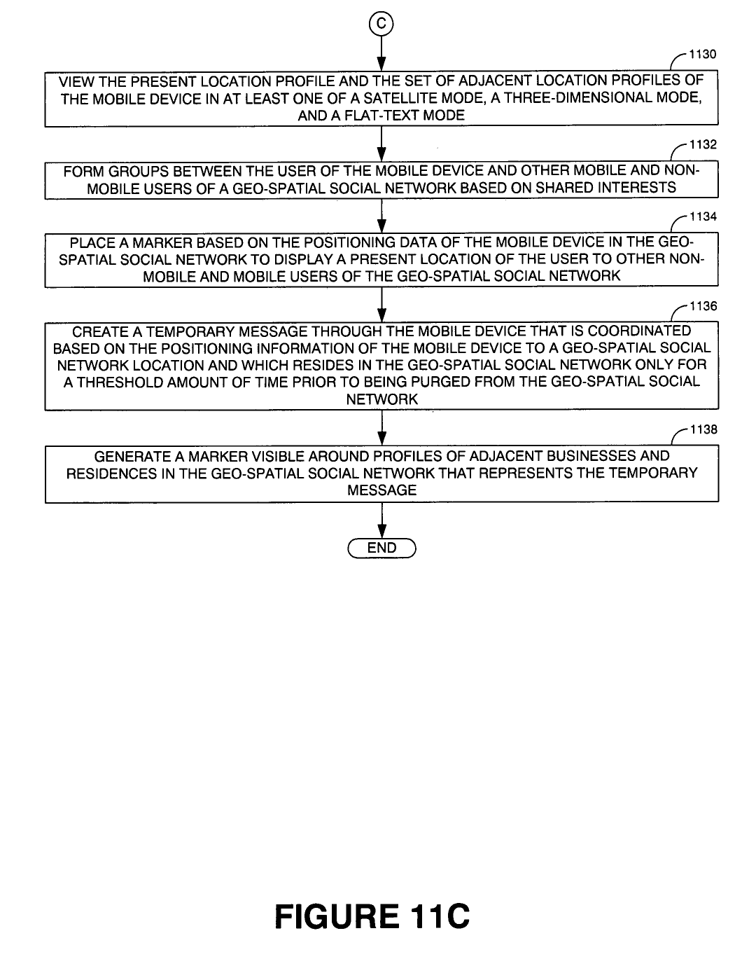

FIG. 11A is a process flow of generating a present location profile and a set of adjacent profiles in a mobile device, according to one embodiment. In operation 1102, a positioning data of the mobile device (e.g., the mobile device 136 of FIG. 1) may be communicated to a server (e.g., the server 100 of FIG. 1) at a periodic interval. In operation 1104, a present location profile associated with a present geographic location of the mobile device 136 may be generated automatically in the mobile device 136 in response to the server. In operation 1106, a set of adjacent profiles provided by the server may be generated simultaneously in the mobile device 136 as being a direction away from the present geographic location of the mobile device 136.

In operation 1108, the present location profile and/or the set of adjacent profiles may be refreshed in the mobile device at the periodic interval. In operation 1110, a present sense data may be attached automatically in the present location profile when a user selects a capture function in the present location profile. In operation 1112, a wiki interface may be provided that enables the user of the mobile device 136 to add profiles and/or to modify any information associated with the present sense profile and/or the set of adjacent profiles when the present sense profile and/or the set of adjacent profiles are not claimed by another user. In operation 1114, certain profiles may be locked when they have been claimed by a claiming user at the discretion of the claiming user.

FIG. 11B is a continuation of process flow of FIG. 11A illustrating additional processes, according to one embodiment. In operation 1116, a triangulation algorithm may be applied to generate a compass view in the mobile device that represents each adjacent profile as being in front of, behind, to the left of and/or to the right of the mobile device 136. In operation 1118, a coupon provided by a business (e.g., the business 132 of FIG. 1) may be generated in the mobile device 136 in a vicinity of the present geographic location of the mobile device 136. In operation 1120, the coupon may be redeemed in the mobile device 136 through a mobile payment algorithm when the user purchases an item associated with the coupon. In operation 1122, the item may be reserved at the business in the vicinity of the geographic location of the mobile device.

In operation 1124, a classified view of purchasable items at homes near the present geographic location of the mobile device when residents of the homes market goods they no longer want may be generated in a geo-spatial social network (e.g., the geo-spatial social network 124 of FIG. 1) associated with the server. In operation 1126, an announcement of the residents may be published to be shared with mobile devices 136 around homes of the residents who publish the announcement. In operation 1128, directions may be generated between the mobile device 136 and an adjacent location without requiring a user of the mobile device 136 to enter a starting address by applying a directions algorithm based on the positioning data of the mobile device 136 as the starting address and a destination address identified in a particular adjacent profile associated with the adjacent location.

FIG. 11C is a continuation of process flow of FIG. 11B illustrating additional processes, according to one embodiment. In operation 1130, the present location profile and the set of adjacent location profiles of the mobile device 136 may be viewed in a satellite mode, a three-dimensional mode, and/or a flat-text mode. In operation 1132, groups may be formed between the user of the mobile device 136 and other mobile and non-mobile users of a geo-spatial social network (e.g., the geo-spatial social network 124 of FIG. 1) based on shared interests. In operation 1134, a marker may be placed based on the positioning data of the mobile device 136 in the geo-spatial social network to display a present location of the user to other non-mobile and mobile users of the geo-spatial social network 124.

In operation 1136, a temporary message may be created through the mobile device 136 which is coordinated based on the positioning information of the mobile device 136 to the geo-spatial social network 124 location and which resides in the geo-spatial social network 124 only for a threshold amount of time prior to being purged from the geo-spatial social network 124. In operation 1138, a marker visible around profiles of adjacent businesses and/or residences in the geo-spatial social network may be generated that represents the temporary message.

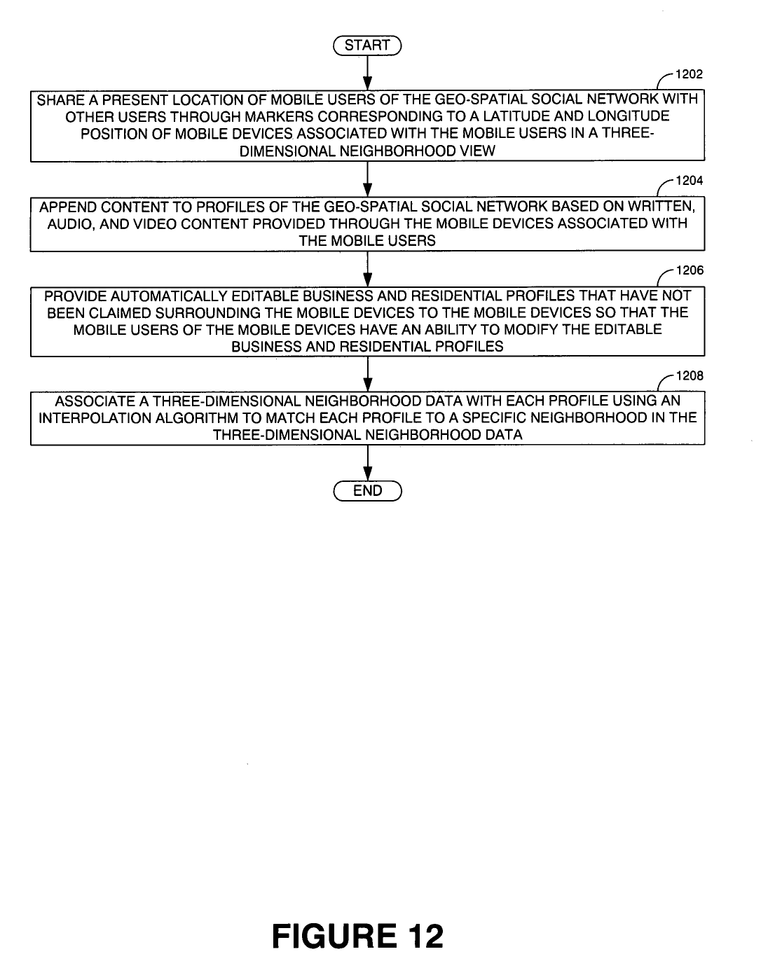

FIG. 12 is a process flow of sharing the present location of the mobile user with the other users through markers, according to one embodiment. In operation 1202, a present location of mobile users of the geo-spatial social network 124 may be shared with other users through markers corresponding to a latitude and longitude position of mobile devices 136 associated with the mobile users in a three-dimensional neighborhood view. In operation 1204, content may be appended to the profiles of the geo-spatial social network 124 based on written, audio, and/or video content provided through the mobile devices 136 associated with the mobile users.

In operation 1206, editable business and/or residential profile that have not been claimed surrounding the mobile devices 136 may be provided automatically to the mobile devices 136 so that the mobile users of the mobile devices 136 have an ability to modify the editable business and residential profiles. In operation 1208, three-dimensional neighborhood data may be associated with each profile using an interpolation algorithm to match each profile to a specific neighborhood in the three-dimensional neighborhood data.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example, the location module 102, the adjacent location module 104, the present geographic location module 106, the present sense impression module 108, the advertising module 110, the commerce module 112, the algorithm module 114, the marker module 116, the group module 118, the profile module 120, the map module 122, the wiki module 202, the location profile module 204, the edit module 210, the refresh module 212, the information module 302, the category module 304, the coupon module 306, the temporary message module 308, the time module 310, the search module 312, the create module 314 and the positioning module 414 of FIGS. 1-12 may be enabled using a location circuit, an adjacent location circuit, a present geographic location circuit, a present sense impression circuit, an advertising circuit, a commerce circuit, an algorithm circuit, a marker circuit, a group circuit, a profile circuit, a map circuit, a wiki circuit, a location profile circuit, an edit circuit, a refresh circuit, an information circuit, a category circuit, a coupon circuit, a temporary message circuit, a time circuit, a search circuit, a create circuit and a positioning circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a mobile device comprising:
communicating a positioning data of the mobile device to a server at a periodic interval;
automatically generating in the mobile device, in response to the server, a present location profile associated with a present geographic location of the mobile device;
simultaneously generating, in the mobile device, a set of adjacent profiles provided by the server as being a direction away from the present geographic location of the mobile device; and
refreshing, in the mobile device, the present location profile and the set of adjacent profiles at the periodic interval.

2. The method of claim 1 further comprising:
automatically attaching a present sense data in the present location profile when a user selects a capture function in the present location profile, wherein the present sense data is at least one of a textual data, a visual data, an auditory data, a video data, and an audio-visual data surrounding a place presently being perceived by the user of the mobile device.

3. The method of claim 2 further comprising providing a wiki interface that enables the user of the mobile device to add profiles and to modify any information associated with the present sense profile and the set of adjacent profiles when the present sense profile and the set of adjacent profiles are not claimed by another user.

4. The method of claim 3 further comprising locking certain profiles when they have been claimed by a claiming user at the discretion of the claiming user.

5. The method of claim 4 wherein the present location profile and the set of adjacent profiles include both residential and business listings.

6. The method of claim 3 further comprising applying a triangulation algorithm to generate a compass view in the mobile device that represents each adjacent profile as being in front of, behind, to the left of, and to the right of the mobile device.

7. The method of claim 1 further comprising generating the positioning data using a positioning algorithm, wherein the positioning algorithm is at least one of a global positioning algorithm and a radio algorithm.

8. The method of claim 1 further comprising generating, in the mobile device, a coupon provided by a business in a vicinity of the present geographic location of the mobile device.

9. The method of claim 8 further comprising:
redeeming in the mobile device the coupon through a mobile payment algorithm when the user purchases an item associated with the coupon; and
reserving the item at the business in the vicinity of the present geographic location of the mobile device.

10. The method of claim 9 further comprising:
generating a classified view of purchasable items at homes near the present geographic location of the mobile device when residents of the homes market goods they no longer want in a geo-spatial social network associated with the server; and
publishing an announcement of the residents to be shared with mobile devices around homes of the residents who publish the announcement.

11. The method of claim 10 wherein the residents market goods they no longer want by marking them as a free status, a for loan status, a for rent status, and a for sale status.

12. The method of claim 1 further comprising generating directions between the mobile device and an adjacent location without requiring a user of the mobile device to enter a starting address by applying a directions algorithm based on the positioning data of the mobile device as the starting address and a destination address identified in a particular adjacent profile associated with the adjacent location.

13. The method of claim 2 further comprising viewing the present location profile and the set of adjacent location profiles of the mobile device in at least one of a satellite mode, a three-dimensional mode, and a flat-text mode.

14. The method of claim 13 further comprising:
forming groups between the user of the mobile device and other mobile and non-mobile users of a geo-spatial social network based on shared interests; and
placing a marker based on the positioning data of the mobile device in the geo-spatial social network to display a present location of the user to other non-mobile and mobile users of the geo-spatial social network.

15. The method of claim 1 further comprising:
creating a temporary message through the mobile device that is coordinated based on the positioning information of the mobile device to a geo-spatial social network location and which resides in the geo-spatial social network only for a threshold amount of time prior to being purged from the geo-spatial social network; and
generating a marker visible around profiles of adjacent businesses and residences in the geo-spatial social network that represents the temporary message.

16. The method of claim 1 in a form of a machine-readable medium embodying a set of instructions that, when executed by a machine, causes the machine to perform the method of claim 1.

17. A system, comprising:
a server to simplify a geo-spatial social network to operate through a mobile communications infrastructure, in which profiles of the geo-spatial social network are editable by any user of the geo-spatial social network until they are claimed by a user of the geo-spatial social network; and
a mobile device to generate a view of profiles of the geo-spatial social network that are a threshold radius away from the mobile device and to automatically capture content to be appended to wiki profiles of the geo-spatial social network by attaching a location data of the mobile device acquired through a positioning module of the mobile device with a particular wiki profile of the geo-spatial social network.

18. The system of claim 17 further comprising an advertising module to capture classified advertisements, messages, and coupons from businesses and residents surrounding the mobile device and to share them with a user of the mobile device.

19. A method of a geo-spatial social network comprising:
sharing a present location of mobile users of the geo-spatial social network with other users through markers corresponding to a latitude and longitude position of mobile devices associated with the mobile users in a three-dimensional neighborhood view;
appending content to profiles of the geo-spatial social network based on written, audio, and video content provided through the mobile devices associated with the mobile users; and
automatically providing editable business and residential profiles that have not been claimed surrounding the mobile devices to the mobile devices so that the mobile users of the mobile devices have an ability to modify the editable business and residential profiles.

20. The method of claim 19 further comprising associating a three-dimensional neighborhood data with each profile using an interpolation algorithm to match each profile to a specific neighborhood in the three-dimensional neighborhood data.
